(19) United States
(12) Patent Application Publication
(10) Pub. No.: US 2026/0327009 A1
(43) Pub. Date: Oct. 22, 2026

(54) ACCESS STATION WITH LIGHT GUIDES FOR AN AUTOMATED STORAGE AND RETRIEVAL SYSTEM HAVING A STORAGE GRID

(71) Applicant: Autostore Technology AS, Nedre Vats (NO)

(72) Inventor: Benjamin Guenter, Nedre Vats (NO)

(73) Assignee: Autostore Technology AS, Nedre Vats (NO)

(21) Appl. No.: 19/486,216

(22) PCT Filed: May 30, 2024
(86) PCT No.: PCT/EP2024/064906

§ 371 Date: Nov. 20, 2025

(30) Foreign Application Priority Data
May 30, 2023 (NO) 20230612

(51) Int. Cl. B65G 1/137; B65G 1/04; B65G 1/06

(52) U.S. Cl. CPC B65G 1/1378; B65G 1/0464; B65G 1/0478; B65G 1/065

(57) ABSTRACT

An access station for an automated storage and retrieval system comprises a frame structure enclosing a receiving space for receiving a storage container, an access opening for accessing the receiving space from externally, at least one optical projection unit having an optical output and configured to project optical information, and a processing unit coupled with the projection unit, wherein the optical output of the projection unit is directed to the receiving space, such that the projection unit is capable of projecting the optical information onto at least one interior face of a storage container arranged in the receiving space, and wherein the processing unit is configured to control an operation of the projection unit to selectively project optical information into the storage container arranged in the receiving space to instruct a user of the access station where and/or how to place items into the storage container.

### TECHNICAL FIELD

The present disclosure relates to an access station of an automated storage and retrieval system, to an automated storage and retrieval system, and to a method for guiding a user where and/or how to place items into a storage container.

### BACKGROUND

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns are storage columns 105, i.e. columns 105 where storage containers 106 are stored in stacks 107. In addition to storage columns 105, there are special-purpose columns within the framework structure. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

WO 2021/122218 A1 particularly shows a picking system configured to pick items from, and put items into, storage containers. A camera is configured to produce an image of contents of a storage container and is connected to an image processing system. A robotic picking device is coupled with the image processing system and picks a specific item from the storage container based on the position determined by the image processing system.

### SUMMARY

This summary is provided to introduce in simplified form a selection of concepts that are further described herein. The summary is not intended to identify key or essential features of the invention.

An aim of the present disclosure lies in providing a solution for guiding a user where and/or how to place items into a storage container at an access station.

The present disclosure is set forth and characterized in the independent claims, while the dependent claims describe other characteristics of the present disclosure.

In one aspect, the present disclosure is related to an access station for an automated storage and retrieval system having a storage section for storing storage containers, the access station comprising a frame structure providing a receiving space for receiving a storage container to be transferred from or into the storage section, an access opening for accessing the receiving space from externally of the access station, at least one optical projection unit having an optical output and being configured to project optical information through the optical output onto at least one interior face of a storage container arranged in the receiving space, and a processing unit coupled with the at least one projection unit, wherein the optical output of the at least one projection unit is directed to the receiving space, such that the at least one projection unit is capable of projecting the optical information onto at least one interior face of a storage container arranged in the receiving space beneath the access opening, and wherein the processing unit is configured to control an operation of the at least one projection unit to selectively project optical information into the storage container arranged in the receiving space to instruct a user of the access station where and/or how to place items into the storage container.

The frame structure may be an assembly of components that form a part of the access station. Inside the frame structure, the receiving space is provided. Preferably, the receiving space is enclosed by the frame structure at least partially such that the receiving space is accessible from outside the frame structure only through the access opening. Preferably, the access station comprises a cover element that selectively covers or uncovers the access opening.

The receiving space may be arranged at an end of a conveying path, along which storage containers are conveyed to and from the receiving space. The receiving space is capable of receiving storage containers, preferably one storage container at a time, delivered from a storage section of an automated storage and retrieval system. The dimensions of the receiving space are chosen to allow receiving any one of the storage containers stored in the storage section. A conveying device may reach into or extend to the receiving space, such that a storage container, which is conveyed by the conveying device, is movable into and removable from the receiving space. The conveying device may be in the form of a conveyor or a carousel. However, shuttle-like robots may be used, which convey storage containers through an access device.

The access opening may be arranged at a top of the access station in a convenient working height. The access opening may have a front edge and a rear edge, wherein the front edge is considered the edge arranged adjacent to a user position, where a user is present to interact with the access station. The rear edge is considered the edge placed further to the storage section and preferably opposed to the front edge. The access opening allows a user to gain access to a storage container that is placed in the receiving space, when it is not closed by a cover element or the like. The access opening may be substantially horizontal, i.e. it may span up a plane that is substantially parallel to a floor underneath the access station or it may be slightly inclined, such that the rear edge of the access opening is arranged in a slightly higher position than the front edge. The size of the access opening may correspond to the internal area of the storage container so as to allow access to the storage container while keeping the storage container on a storage side of the access opening. Once the storage container has been accessed at the access station it may be returned to a storage column of the automated storage and retrieval system.

A user may conduct various tasks at the access station. For example, the user may pick items from the respective storage container that is placed in the receiving space or put items into the storage container by moving them through the access opening. After the desired tasks at the storage container are accomplished, the storage container may be conveyed back into the storage section of the automated storage and retrieval system.

The tasks to be carried out by the user may be diverse and may include actions that may not be performed intuitively or in a routine manner, depending on the diversity of items stored in the storage and retrieval system. Items of different sizes and weights may need to be placed in a certain way to optimize the space utilization and/or the weight distribution. To guide a user to efficiently place items into a storage container for improving the utilization of the storage container, the access station according to the present disclosure comprises at least one optical projection unit.

The at least one optical projection unit has an optical output and is configured to emit light through the optical output, which is accomplished by a light source. The light source is preferably configured to emit light in the visible spectrum. Light emitted from the light source may comprise or form at least one of a light beam, a bundle of light beams in a focused or a fanned-out shape, a static pattern, and a moving pattern. A pattern may be considered as a perceivable structure formed by light to convey information to a user. The at least one optical projection unit is aligned to direct the emitted light into the receiving space, i.e. into a storage container located therein. The emitted light impinges onto a bottom and/or at least one side wall of the storage container.

Hence, the at least one optical projection unit is capable of displaying information inside the storage container that is placed in the receiving space. A user that is present at the access station and looks into the access opening easily perceives the emitted light and the associated information. Depending on the operation of the at least one optical projection unit, guidance information can be provided. Thus, by controlling the operation of the at least one projection unit through the processing unit, the user who is considered to conduct a task at the access station can be guided.

The processing unit may be connected to a control system of the automated storage and retrieval system, with which the access station is associated. The processing unit may receive information about the tasks to be conducted at the access station from the control system or from another system that is capable of planning the tasks to be conducted. These tasks may comprise placing several items into the storage container. The processing unit and/or the control system and/or another system may be capable of executing a space optimization algorithm and/or a weight distribution optimization algorithm, or the like. A result from such an algorithm may comprise position and alignment recommendations for arranging items inside the storage container.

These can be processed by the processing unit to operate the at least one optical projection unit for displaying suitable information inside the storage container to guide the user. For example, contours or footprints or identifiers of the items may be projected onto at least one side wall or a bottom of the storage container to indicate their recommended positions. If a plurality of items are to be placed into the storage container at once, the item contours of all items may be projected onto the at least one side wall or the bottom simultaneously, one-by-one and/or in an alternating manner. To raise the attention of the user to a particular item, the respective contour or other pattern may be flashing or blinking, or it may change its colors.

The access station according to the present disclosure may thus be capable of guiding a user where and/or how to place items into a storage container located inside the receiving space to optimize the utilization of space and/or weight distribution by controlling the operation of at least one optical projection unit through a processing unit to display user-perceivable information directly into the storage container.

The processing unit may be configured to receive data or information to be projected by the at least one projection unit. It may be configured to process the data or information to create image data to be projected. For example, the control system may simply specify information about items to be placed inside a storage container, such as sizes, numbers, and maybe locations, while the processing unit may generate images, or graphics to be projected. A processing of the data or information in the processing may reduce the data transfer between the control system and the processing unit. The processing unit may be responsible for providing all correct proportions of the items when projected onto the at least one interior face of the storage container If the at least one projection unit projects optical information to the respective interior face at an angle, e.g. when the at least one projection unit is not placed perpendicular to the respective interior face, the projection may be distorted. For example, squares projected onto the respective interior face or the boundary edges of the projection appear like a trapezoid. The processing unit may be configured to conduct a keystone correction on the image data, such that the resulting projection on the interior face appears undistorted and has parallel pairs of boundary edges and a correct aspect ratio to the user looking into the storage container.

If a plurality of projection units is used, each of the projection units may cover a different portion of an image. The processing unit may be configured to process the data or information to provide separate partial image data to be projected by the plurality of projection units. The processing unit may be configured to adjust and/or coordinate the individual separate partial image data in a way that the resulting individual projections are flush with each other in order to form a complete image.

Also, the processing unit may be configured to provide separate different image data to a plurality of projection units in order to provide different information on different interior faces.

The optical output may be arranged at a distance to the access opening away from the receiving space. Thus, the optical output is not arranged inside the receiving space, but at a distance thereto. The optical output may be arranged substantially above the access opening, which includes a placement directly above a center of the access opening, or further to one of the sides, and/or further to the front edge and/or further to the rear edge. The light emitted by the optical projection unit will thus enter the receiving space substantially from above. When arranging the optical output above the access opening, it should be avoided that light will be emitted directly into the face of the user at the access station. For this purpose, the at least one projection unit may comprise light shielding flaps, a housing having a certain light guiding cavity, and/or other types of shields to adjust the beam angles. The at least one optical projection unit may also comprise an intrinsic radiation characteristic that allows to precisely direct the emitted light only into the receiving space. When placing the optical output directly above the access opening, the optical information may mainly be projected onto the bottom wall of the storage container. When arranging the optical output further to one of the sides, i.e. further to one of the limiting edges of the access opening, and/or further to the front edge of the access opening, optical information may also be projected onto one or more side walls of the storage container.

The optical output of the at least one projection unit may be off-center relative to the access opening. Thus, when placing the at least one projection unit outside the access opening and outside the receiving space off-center, the user of the access station has a great radius of operation around the access opening. Due to the position and orientation of the output side, light can simply be projected onto the bottom and onto sidewalls of the storage container, which allows to provide distinct information on the bottom and the sidewalls. For example, stacking levels or heights, textual information and the like can be displayed on the sidewalls, while the footprints of the items may be displayed on the bottom. The term “off-center” may be understood as being shifted further to the rear edge, to the front edge, or to one of the lateral edges above the access opening. The greatest radius of operation may be reached if the optical output is moved further to the rear edge.

The at least one projection unit may be arranged above the access opening and inside the opening contour, i.e. the perimeter of the access opening. The optical output may thus be placed within a footprint of the perimeter. This allows the optical output to reach all the interior faces of the container.

The at least one projection unit may comprise a stand having a base, a free end, and at least one arm member extending between the base and the free end, wherein the base may be attached to a top of the access station adjacent to the access opening and in a distance thereto, and wherein the stand may extend away from the top of the access station, such that the optical output is arranged at a distance to the access opening and is oriented towards the access opening. An arm member may be realized in the form of an elongated element. The stand may be connected to the access station through the base. The stand may be rigidly connected to the access station, i.e. in an immovable state. Also, the base may include a first joint or a first joint assembly that allows to adjust the orientation of the stand relative to the access station. The first joint or first joint assembly may comprise at least one axis and preferably at least two axes of rotation. It is conceivable that the state of the first joint or first joint assembly after adjusting the orientation of the stand relative to the access station can be locked or latched. The stand may comprise a plurality of arm members, e.g. two or three arm members, which are connected to each other in an articulated manner. Hence, the stand is provided in the form of an arm having one or more arm members that are connected to each other, to ensure a positionability of the optical outlet above the access opening. For this, the arm members are connected to each other through a second joint or a second joint assembly. The second joint or second joint assembly may comprise at least one axis and preferably at least two axes of rotation. The state of the second joint or second joint assembly may be locked or latched after adjusting the orientation of the arm members relative to each other. The optical output may be arranged at the free end of the arm, i.e. the end of the stand opposite to the base. Here, the optical output may be swivably supported on the arm through a third joint or third joint assembly. The third joint or third joint assembly may comprise at least one axis and preferably at least two axes of rotation, such that the orientation of the optical output can be adjusted. In analogy to the above, the state of the third joint or third joint assembly may be locked or latched after adjusting the orientation of the optical output. The term “joint assembly” may be understood as a combination of at least two joints, preferably two joints with a single axis of rotation each.

In an alternative to this, the stand may also be a bendable. The stand may thus be realized in the form of a gooseneck or flex arm, which is a semi-rigid, flexible connecting element made of coiled metal tubing. It may be bent in almost any direction and may remain in its position.

As mentioned further above, the processing unit may be configured to provide a keystone correction. This may be done manually by adjusting the keystone correction when re-positioning the optical outlet. However, the stand may comprise a sensor couplable with the processing unit, such that the processing unit is configured to automatically adjust the keystone correction depending on the actual position of the optical outlet. Also, the outlet may comprise a sensor couplable with the processing unit to allow adjusting a keystone correction.

The access opening may comprise an opening contour having a front edge, a rear edge, and two lateral edges, wherein the at least one projection unit may be arranged on an edge region of at least one of the two lateral edges, and wherein the optical output may face into the receiving space. Thus, the at least one projection unit does not require a stand or another holding device that is arranged outside, i.e. above, the access opening. The radius of operation for a user will thus be as large as possible and damaging the at least one projection unit by a user handling items above or on the top of the access station can be avoided. Instead, the at least one projection unit is integrated into, placed at or placed under the respective edge and faces directly into the receiving space. Blinding a user due to misaligned optical projection unit will be avoided to a greatest possible extent and the access station has a structurally clean top. The at least one projection unit may be configured to switch off if the optical output is not positioned to the receiving space. This may be done with a mechanical switch or an angle sensor coupled with the respective projection unit. The distance from the at least one projection unit to the respective interior face of the storage container in the receiving space can be reduced as much as possible. Also, the use of several projection units, which each face into different directions, is possible without any restrictions on the user's workspace. Also, multiple projection units may be adjacent to each other at the same edge. The several projection units may be used for providing different information on different side walls and/or the bottom of the storage container if desired. While it may be possible to also project optical information onto the front wall of the storage container, i.e. through an optical projection unit at the rear edge of the access opening, it may be hard to see for a user of the access station.

The at least one of the two lateral edges may comprise an edge body that at least partially forms the respective edge, wherein the edge body may have at least one transparent section, and wherein the at least one projection unit may be arranged inside the at least one transparent section. For example, the edge body is an elongated component that at least partially and preferably completely extends along the respective edge of the access opening. It may comprise a partial circle or a polygonal shape, e.g. with rounded edges, as a cross-sectional contour. The at least one optical projection unit may be arranged inside a transparent section of the edge body, such that light emitted by the at least one projection unit, i.e. the optical output, can pass through the transparent wall of the edge body to reach the receiving space. Preferably, the at least one projection unit may be arranged completely inside the corresponding edge body. However, also one end of a fiber optic cable may reach into the transparent section of the edge body, while another end of the fiber optic cable may be coupled with a projection unit arranged in the access station underneath a top and in a distance to the access opening. The at least one projection unit can thus be protected against impacts from items handled by the user, such that damages of the at least one projection unit can be avoided. It is conceivable that the edge body is completely transparent. It may consist of a single tubular element. The at least one projection unit is arranged inside the edge body at a desired location. In the desired location, it may be attached to the edge body by screwing, gluing, or any other positive or non-positive connection. An integration of the at least one optical projection unit into the edge leads to a least possible restriction on the user's workspace. The at least one projection unit may be miniaturized.

The at least one projection unit may have an inclined optical axis extending from the optical output to a diametrically opposed bottom region of the receiving space. The optical axis is to be understood as an imaginary symmetry line from the optical output, along which the emitted light propagates. If the at least one projection unit is arranged at an edge region, it may be aligned in a way that the optical axis runs diagonally in the receiving space. The at least one projection unit may emit a bundle of light beams in a fanned-out shape, such that they impinge on the respective opposed side wall as well as the bottom of the storage container. The opposed bottom region may be understood as a part of the bottom or a side wall near or directly above the bottom of the storage container inside the receiving space at an opposite side of the receiving space. If a plurality of optical projection units are provided at a plurality of edges of the axis opening, their projection fields may intersect and substantially all sidewalls visible for the user can be sued for projecting information.

The light emitted by the at least one optical projection unit may produce a focused image of the right height and proportions when it hits the respective interior face of the storage container. When an item is already put into the storage container, the processing unit may adjust the respective image data to follow around the surface of the item, as it may be considered a part of the projection surface

The optical information may comprise at least one of a group of optical information, the group comprising: static optical information, moving optical information, a graphical representation of an item to be placed in a storage container, a number, a text, a symbol, an arrow, and a geometric shape. Static optical information may simply comprise contours of items to be placed, identifiers, such as numbers, names, product codes, or the like. Moving optical information may include substantially the same, but the location of the information projected onto sidewalls of the container or the bottom may change their location, color, appearance, size, etc. during the projection. A graphical representation may be a contour, a drawing or a photo showing the respective item. It is conceivable to customize the access station to the needs of the user depending on the items to be placed into the storage containers. This may be achieved by providing a software-based framework in the processing unit that allows to include the desired information and their behavior during projection.

The at least one projection unit may comprise an LCD projector, a DLP projector, an LED projector and/or a LASER projector. In particular, a LASER based projection unit can be provided in a miniaturized type, which may be simple to integrate into the above-identified edge body.

In a second aspect, the present disclosure concerns an automated storage and retrieval system, comprising a plurality of stacks of storage containers arranged in storage columns; a control system for monitoring and controlling the automated storage and retrieval system; and at least one access station according to any of the preceding claims, wherein the storage and retrieval system is adapted to selectively move storage containers from one of the storage columns into the receiving space of the at least one access station and vice versa. The access station may be directly connected to the automated storage and retrieval system through a conveying device.

The automated storage and retrieval system may further comprise a rail system having a first set of parallel rails arranged in a horizontal plane and extending in a first direction, and a second set of parallel rails arranged in the horizontal plane and extending in a second direction which is orthogonal to the first direction, which first and second sets of rails form a grid pattern in the horizontal plane comprising a plurality of adjacent grid cells, each comprising a grid opening defined by a pair of neighboring rails of the first set of rails and a pair of neighboring rails of the second set of rails, wherein the rail system is located above the storage columns, wherein each storage column is located vertically below a grid opening; and a plurality of container handling vehicles for handling storage containers in the automated storage and retrieval system, each vehicle being configured to move on the rail system above the storage columns.

The processing unit of the access station may be coupled with the control system; wherein the processing unit may be configured to receive information from the control system about items to be placed into a defined storage container; wherein the storage and retrieval system may be configured to convey the defined storage container into the receiving space of the access station; and wherein the processing unit may be configured to control the at least one projection unit based on the information received from the control system.

The processing unit and/or the control system may be configured to conduct a space allocation algorithm based on the information received from the control system to generate a placement recommendation for the items, and wherein the processing unit may be configured to control the at least one projection unit based on the placement recommendation. Different approaches for solving a space allocation problem exist. For example, the “Bin Packing Problem” and the “Knapsack Problem” are commonly known combinatorial optimization problems, which may be solved by a variety of different algorithms, which are known to the skilled person. For example, they may include Next Fit, First Fit, Best Fit, First Fit Decreasing, Best Fit Decreasing, Greedy method, Dynamic Programming method, and Back Tracking method.

In a third aspect the present disclosure is directed to a method for guiding a user where and/or how to place items into a storage container, the method comprising placing a storage container into a receiving space of an access station of an automated storage and retrieval system; retrieving information about items to be placed into the storage container; projecting optical information onto at least one interior face of the storage container to instruct a user of the access station where and/or how to place items into the storage container based on the retrieved information.

Retrieving the information may comprise receiving the information from a control system of the automated storage and retrieval system.

The method may comprise conducting a space allocation algorithm based on the retrieved information to generate a placement recommendation for the items; and projecting information about the items into the storage container based on the placement recommendation.

The optical information may comprise at least one of a group of optical information, the group comprising static optical information, moving optical information, a graphical representation of an item to be placed in a storage container, a number, a text, a symbol, an arrow, and a geometric shape.

### BRIEF DESCRIPTION OF THE DRAWINGS

Following drawings are appended to facilitate the understanding of the present disclosure. The drawings show embodiments of the present disclosure, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of an access station.

FIG. 6 is a perspective view of a modified access station.

FIG. 7 is a perspective view of a storage container in an access station.

FIG. 8 is a net view of the storage container with projected optical information.

FIG. 9 is a perspective view of an automated storage and retrieval system having an access station.

FIG. 10 shows a method of guiding a user in a block-oriented view.

### DETAILED DESCRIPTION

In the following, embodiments of the present disclosure will be discussed in more detail with reference to the appended drawings. It should be understood, however, that the drawings are not intended to limit the present disclosure to the subject-matter depicted in the drawings.

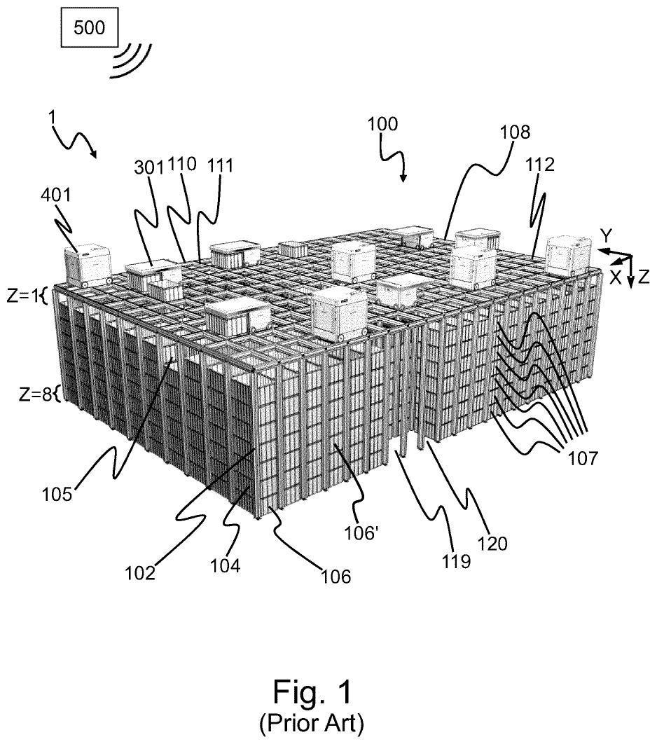

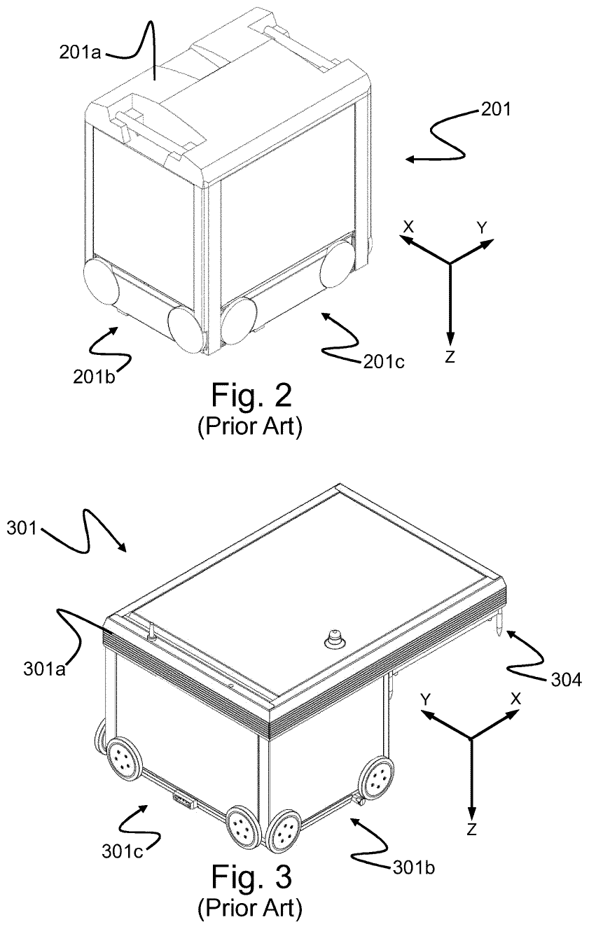

The framework structure 100 of the automated storage and retrieval system 1 is constructed in a similar manner to the prior art framework structure 100 described above in connection with FIGS. 1-3. That is, the framework structure 100 comprises a number of upright members 102, and can comprise a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

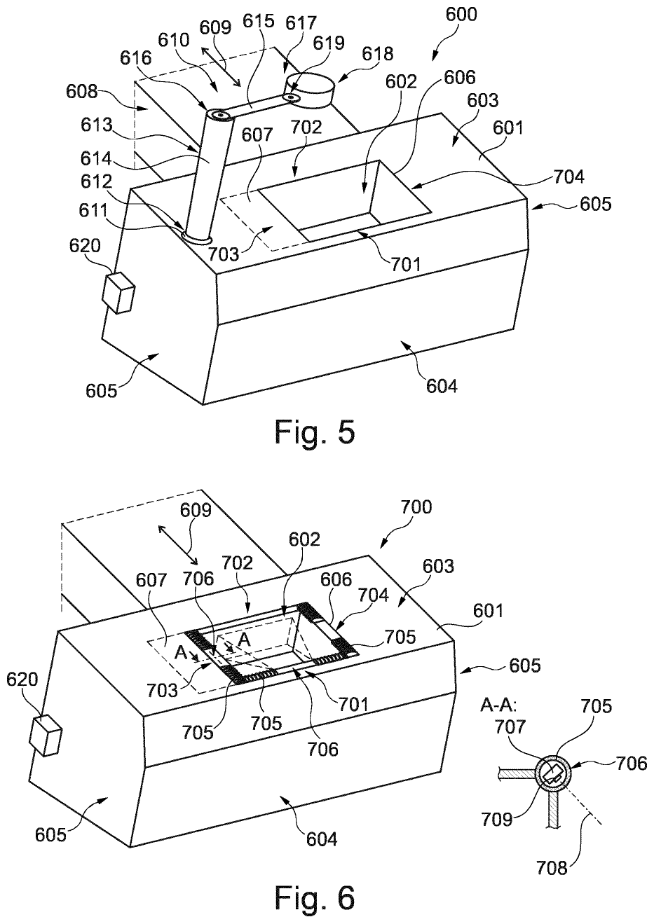

One embodiment of the automated storage and retrieval system according to the present disclosure will now be discussed in more detail with reference to FIGS. 5 to 10.

FIG. 5 shows an access station 600 for an automated storage and retrieval system. The access station 600 has a frame structure 601 which encloses a receiving space 602 for receiving a storage container 106. The frame structure 601 has a top 603, a front 604 and sides 605. The access station 600 furthermore comprises an access opening 606, which allows to access the receiving space 602 from externally of the access station 600. The access opening 606 has a front edge 701. A rear edge 702, and two lateral edges 703 and 704. The front edge 701 faces to the front 604 and to the user of the access station 600, respectively. The top 603 may be aligned substantially horizontally, i.e. parallel to a floor underneath the access station 600 or slightly inclined, such that the rear edge 702 of the access opening 606 is arranged at a slightly greater height than the front edge 701.

Exemplarily, a cover element 607 is provided to selectively cover or uncover the access opening 606. In this illustration, the cover element 607 is partially arranged underneath the top 603 and is thus partially shown with dashed lines. For example, it may move from the left-hand side to the right-hand side and vice versa to close or open the access opening 606. Other embodiments are conceivable.

The receiving space 602 is coupled with a conveying device 608, which is configured to move storage containers 106 along a conveying path 609 to and from the receiving space 602. For example, a storage container 106 can be retrieved from a storage section of an automated storage and retrieval system and be conveyed to the receiving space 602 along the conveying path 609. For removing the storage container 106 from the receiving space 602, it can be moved along the conveying path 609 to the storage section again. A user of the access station 600 will be able to access the storage container 106 present in the receiving space 602 through the access opening 606 if it is not covered by the cover element 607.

The user may accomplish various tasks at the storage container 106, which may include placing items into or removing items from the storage container 106. If the user has to handle a variety of items, the access station 600 according to the present disclosure is able to provide guidance to the user through an optical projection unit 610.

The optical projection unit 610 is attached to the top 603 at a distance to the access opening 606 away from the receiving space 602. In this example, the optical projection unit 610 comprises a base 611, which is fastened to the top 603 adjacent to the access opening 606. Exemplarily, the base 611 comprises a first joint 612, which is exemplarily realized in the form of a ball joint that has two degrees of rotational freedom. The optical projection unit 610 comprises an arm 613 having a first arm member 614 and a second arm member 615. The first arm member 614 is swivably connected to the base 611 through the first joint 612. The second arm member 615 is connected to the first arm member 614 through a second joint 616. The second joint 616 exemplarily comprises a single axis of rotation and thus merely act as a hinge. At a free end 617 of the arm 613, an optical output 618 is provided. The optical output 618 may be connected to the second arm member 615 through a third joint 619, which is exemplarily also a ball joint. The arm 613 allows two place the optical output 618 above the access opening 606. By providing the joints 612, 616 and 619, it is possible to adjust the position and orientation of the optical output 618 in relation to the access opening 606. For preventing inadvertent motion of the optical output 618, the joints 612, 616 and 619 may be lockable.

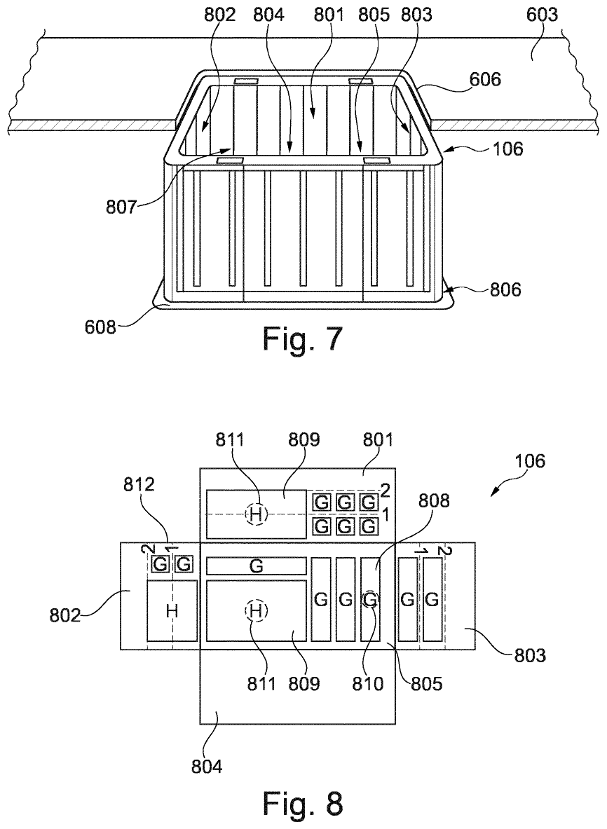

The optical projection unit 610 is configured to project optical information through the optical output 618 into the receiving space 602 and, consequently, onto delimiting walls of a storage container 106. A processing unit 620, which is schematically indicated by a box attached to a side 605, is coupled to the projection unit 610. The processing unit 620 is configured to control an operation of the projection unit 610 to selectively project optical information into the storage container 106 arranged in the receiving space 600. This allows to instruct a user of the access station 600 where and/or how to place items into the storage container 106. The exemplary placement of the optical output 618 above the access opening 606 allows to project information substantially on all delimiting walls of the storage container 106. Further examples how the optical information and the information contained therein allow to guide a user of the access station 600 will be shown in FIGS. 7 and 8.

FIG. 6 shows an access station 700, which has a slightly modified design compared to the access station 600 of FIG. 5. Here, the lateral edges 703 and 704 as well as the front edge 701 comprise an edge body 705, that forms the respective edge 701, 703, and 704. The edge bodies 705 are exemplarily provided in the form of elongated components with a constant cross-sectional profile. The edge bodies 705 may be made from a sturdy plastic material, such as ABS (acrylnitril butadien styrol), PC (poly carbonate), PPSU (polyphenylsulfone), or UHMW (ultra high molecular weight polyethylene). Other materials are conceivable.

Each of the edge bodies 705 has a transparent section 706, inside which a miniaturized projection unit 707 is arranged. It is conceivable that the edge bodies 705 are completely transparent and the above-mentioned materials are suitable for this purpose.

As shown in the sectional detail A-A, the edge body 705 arranged at the left-hand side lateral edge 703 exemplarily has a circular cross-section, inside which a miniaturized projection unit 707 having an optical output 709 is arranged. The projection unit 707 faces into the receiving space 602 and comprises an optical axis 708 that is directed towards an opposed edge of a bottom surface of a storage container 106. In this example, the three edges 701, 703, and 704 comprise such an edge body 705 with integrated projection unit 707. Consequently, optical information can be projected onto a plurality of walls of a storage container 106.

By integrating the optical projection units 707 into the edge bodies 705, the top 603 of the access station 700 remains free from any additional installations. Thus, the radius of operation for a user at the access station 700 is clearly increased compared to the solution in FIG. 5. Additionally, the projection units 707 are protected from potential damages through impacts with items handled by a user.

FIG. 7 shows a storage container 106 in the access opening 606 of the access station 600 of FIG. 5. Here, the top 603 of the access station 600 is partially cut away to get a full view of the storage container 106. The storage container 106 comprises a rear wall 801, a left wall 802, a right wall 803, a front wall 804 and a bottom 805. The walls 801 to 804 surround the bottom 805 and extend from the bottom in an upright manner. A support surface 806 of the storage container 106 is placed on the conveying device 608. Opposite thereto, the container has a container opening 807, which is accessible through the access opening 606. By using the projection unit 610 or the projection units 707, optical information may be projected onto the walls 801 to 804 as well as onto the bottom 805.

FIG. 8 shows the container 106 in a net view, i.e. with a planar arrangement of the surfaces of the walls 801 to 804 and the bottom 805. Here, a plurality of item contours 808 and 809 are displayed onto the bottom 805. A user standing at the access station 600 or 700 looking into the storage container 106 underneath the access opening 606 would be able to see the contours 808 and 809. The contours 808 and 809 differ in size and shape.

In this example it is assumed that the storage container 106 is empty and presented at the respective access station 600 or 700. A user is supposed to pick several items from another storage container in another access station or the like to place them into the empty storage container 106 presented at the access station 600 or 700. Here, four items have a rather elongated shape, and one item is larger and bulkier. The respective contours shown on the bottom 805 indicate a recommended arrangement of the items to utilize the available space on the bottom 805 in an optimal manner. To further guide the user about which items have to be placed where, identifiers 810, here in the form of the letter “G”, and 811, here in the form of the letter “H”, are displayed inside the respective contours. It is conceivable that the contours 808 and 809 as well as the identifiers 810 and 811 are displayed one after another to indicate a recommended sequence. However, they may also be displayed simultaneously.

Exemplarily, stacking level indications 812 are projected onto the walls 801 to 803 to show recommended stacking levels. For example, the bulky item shown with contour 809 and the identifier 811 extends over two stacking levels, while the other items are only extending over one stacking level each and are stacked in two rows.

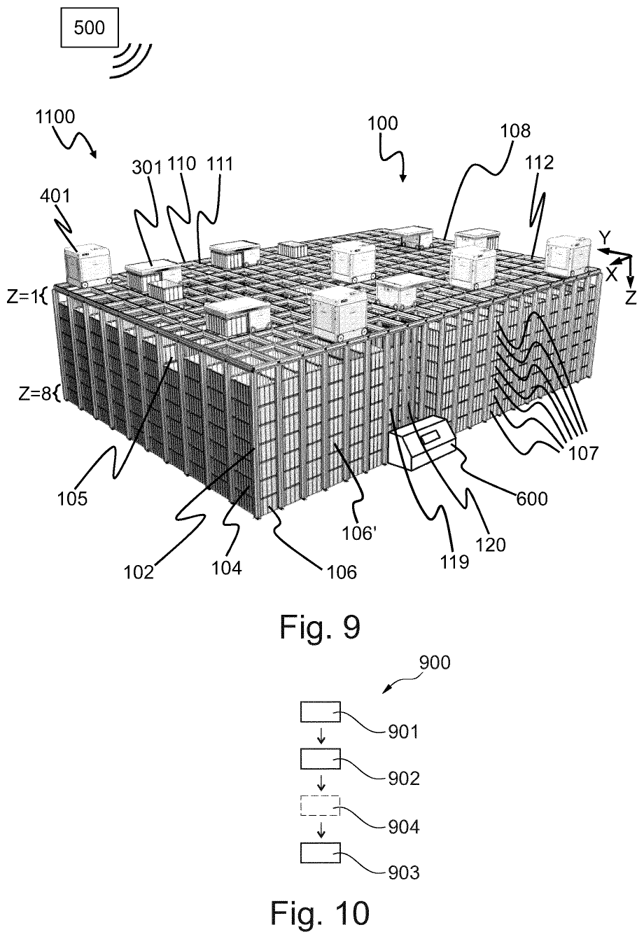

FIG. 9 shows an automated storage and retrieval system 800, which exemplarily corresponds to the one shown in FIG. 1. Thus, it has a framework structure 100 comprising upright members 102 and a storage volume comprising storage columns 105 arranged in rows between the upright members 102. In these storage columns 105 storage containers 106 are stacked one on top of one another to form stacks 107. A plurality of container handling vehicles 201, 301, 401 can operate on a rail system 108 arranged across the top of framework structure 100 to raise storage containers 106 from, and lower storage containers 106 into, the storage columns 105, and also to transport the storage containers 106 above the storage columns 105. For this purpose, the rail system 108 comprises a first set of parallel rails 110 arranged to guide movement of the container handling vehicles 201, 301, 401 in a first direction X across the top of the frame structure 100, and a second set of parallel rails 111 arranged perpendicular to the first set of rails 110 to guide movement of the container handling vehicles 201, 301, 401 in a second direction Y perpendicular to the first direction X. Containers 106 stored in the columns 105 are accessed by the container handling vehicles 201, 301, 401 through access openings 112 in the rail system 108. The container handling vehicles 201, 301, 401 can move laterally above the storage columns 105, i.e. in a plane which is parallel to the horizontal X-Y plane.

In this exemplary embodiment, the automated storage and retrieval system 800 comprises the access station 600 of FIG. 5. The conveying device 608 connects the access station 600 to the storage grid 104 and individual storage containers 106 can be moved to the receiving space 602 of the access station 600 and vice versa.

However, the automated storage and retrieval system 800 may also be equipped with the access station 700 of FIG. 6 in the same manner.

Lastly, FIG. 10 shows a method 900 for guiding a user where and/or how to place items into a storage container 106. The method exemplarily comprises placing 901 a storage container 106 into a receiving space 602 of an access station 600, 700 of an automated storage and retrieval system 800; retrieving 902 information about items to be placed into the storage container 106; and projecting 903 optical information onto at least one interior face of the storage container 106 to instruct a user of the access station 600, 700 where and/or how to place items into the storage container 106 based on the retrieved information. Retrieving 902 the information exemplarily comprises receiving the information from a control system 500 of the automated storage and retrieval system 800. The steps 901 and 902 can also be conducted in reverse order or simultaneously.

Optionally, the method exemplarily comprises conducting 904 a space allocation algorithm based on the retrieved information to create a placement recommendation for the items. Projecting 903 the optical information into the storage container 106 can thus be based on the placement recommendation.

In the preceding description, various aspects of the delivery vehicle and the automated storage and retrieval system according to the present disclosure have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present disclosure.

### LIST OF REFERENCE NUMBERS

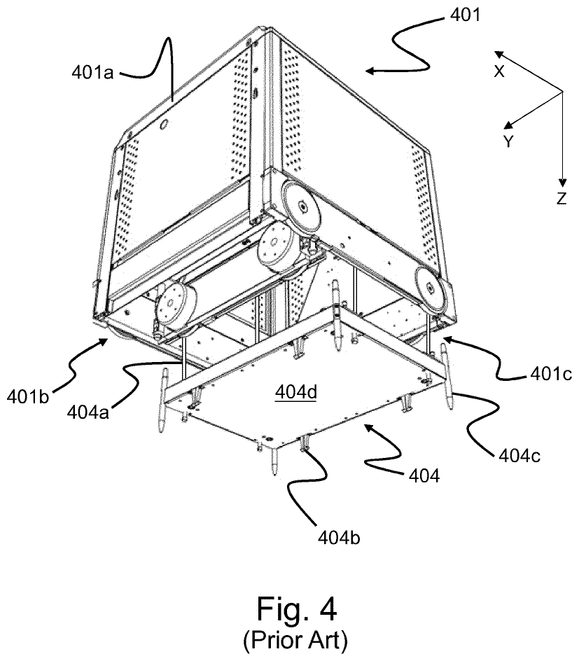

### Prior Art (FIGS. 1-4)

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
2010 Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
600 Access station
601 Frame structure
602 Receiving space
603 Top
604 Front
605 Side
606 Access opening
607 Cover element
608 Conveying device
609 Conveying path
610 Projection unit
611 Base
612 First joint
613 Arm
614 First arm member
615 Second arm member
616 Second joint
617 Free end
618 Optical output
619 Third joint
620 Processing unit
700 Access station
701 Front edge
702 Rear edge
703 Lateral edge (left)
704 Lateral edge (right)
705 Edge body
706 Transparent section
707 Projection unit
708 Optical axis
709 Optical output
800 Automated storage and retrieval system
801 Rear wall
802 Front wall
803 Left wall
804 Right wall
805 Bottom
806 Support surface
807 Container opening
808 Item contour
809 Item contour
810 Identifier
811 Identifier
812 Stacking level indicator
900 Method
901 Placing storage container
902 Retrieving information
903 Projecting optical information
904 Conducting space allocation algorithm

1. An access station for an automated storage and retrieval system having a storage grid, the access station comprising:
a frame structure providing a receiving space for receiving a storage container to be transferred from or into the storage grid,
an access opening for accessing the receiving space from externally of the access station
at least one projection unit having an optical output and being configured to project optical information through the optical output onto at least one interior face of a storage container arranged in the receiving space, and
a processing unit coupled with the at least one projection unit,
wherein the optical output of the at least one projection unit is directed to the receiving space such that the at least one projection unit is capable of projecting the optical information onto at least one interior face of a storage container arranged in the receiving space beneath the access opening, and
wherein the processing unit is configured to control an operation of the at least one projection unit to selectively project optical information into the storage container arranged in the receiving space to instruct a user of the access station where and/or how to place items into the storage container.

2. The access station of claim 1,
wherein the optical output is arranged at a distance to the access opening away from the receiving space.

3. The access station of claim 1,
wherein the optical output of the at least one projection unit is off-center relative to the access opening.

4. The access station of claim 1,
wherein the at least one projection unit comprises a stand having a base a free end and at least one arm member extending between the base and the free end,
wherein the base is attached to a top of the access station adjacent to the access opening and in a distance thereto,
wherein the optical output is arranged at the free end and
wherein the stand extends away from the top of the access station such that the optical output is arranged at a distance to the access opening and is oriented towards the access opening.

5. The access station claim 1,
wherein the access opening comprises an opening contour having a front edge a rear edge and two lateral edges,
wherein the at least one projection unit is arranged on an edge region of at least one of the two lateral edges or the front edge, and
wherein the optical output faces into the receiving space.

6. The access station of claim 5,
wherein the at least one of the two lateral edges or the front edge comprises an edge body at at least partially forms the respective edge,
wherein the edge body has at least one transparent section, and
wherein the at least one projection unit is arranged inside the at least one transparent section

7. The access station of claim 5,
wherein the at least one projection unit has an inclined optical axis extending from the optical output to a diametrically opposed bottom region of the receiving space.

8. The access station of claim 1,
wherein the optical information comprises at least one of
static optical information,
moving optical information,
a graphical representation of an item to be placed in a storage container,
a number,
a text,
a symbol,
an arrow, and
a geometric shape.

9. The access station of claim 1,
wherein the at least one projection unit comprises an LCD projector, a DLP projector, an LED projector and/or a LASER projector.

10. An automated storage and retrieval system comprising:
a plurality of stacks of storage containers arranged in storage columns located beneath a rail system forming a storage grid;
a control system for monitoring and controlling the automated storage and retrieval system; and
at least one access station according to claim 1,
wherein a conveying device of the automated storage and retrieval system is adapted to selectively move storage containers from the storage grid into the receiving space of the at least one access station and vice versa.

11. The automated storage and retrieval system of claim 10, further comprising:
the rail system having a first set of parallel rails arranged in a horizontal plane and extending in a first direction, and a second set of parallel rails arranged in the horizontal plane and extending in a second direction which is orthogonal to the first direction, which first and second sets of rails form a grid pattern in the horizontal plane comprising a plurality of adjacent grid cells, each comprising a grid opening defined by a pair of neighboring rails of the first set of rails and a pair of neighboring rails of the second set of rails, wherein each grid opening is located vertically above a storage column
a plurality of container handling vehicles for handling storage containers in the automated storage and retrieval system, each vehicle being configured to move on the rail system above the storage columns.

12. The automated storage and retrieval system of claims 10,
wherein the processing unit is coupled with the control system;
wherein the processing unit is configured to receive information from the control system about items to be placed into a defined storage container;
wherein the automated storage and retrieval system is configured to convey the defined storage container into the receiving space of the access station; and
wherein the processing unit is configured to control the at least one projection unit based on the information received from the control system.

13. The automated storage and retrieval system of claim 12,
wherein the processing unit and/or the control system is configured to conduct a space allocation algorithm based on the information received from the control system to generate a placement recommendation for the items, and
wherein the processing unit is configured to control the at least one projection unit based on the placement recommendation.

14. A method for guiding a user where and/or how to place items into a storage container, the method comprising:
placing a storage container into a receiving space of an access station of an automated storage and retrieval system;
retrieving information about items to be placed into the storage container; and
projecting optical information onto at least one interior face of the storage container to instruct a user of the access station where and/or how to place items into the storage container based on the retrieved information.

15. The method according to claim 14,
wherein retrieving the information comprises receiving the information from a control system of the automated storage and retrieval system.

16. The method according to claim 14, or further comprising:
conducting a space allocation algorithm based on the retrieved information to generate a placement recommendation for the items; and
projecting information about the items into the storage container based on the placement recommendation.

17. The method according to claim 14,
wherein the optical information comprises at least one of:
static optical information,
moving optical information,
a graphical representation of an item to be placed in a storage container,
a number,
a text,
a symbol,
an arrow, and
a geometric shape.

18. A processing unit configured to control a projection unit based on the information received from a control system to perform the method of any of claims 14.
